(19) United States
(12) Patent Application Publication
(10) Pub. No.: US 2003/0231619 A1
(43) Pub. Date: Dec. 18, 2003

(54) Method and apparatus for voice/data notification system using personal computers and voice/data modems

(76) Inventor: Guner Akturk, Kirkland, WA (US)

Correspondence Address: Guner Akturk, 12206 131st PI NE #E75, Kirkland, WA, 98034, US

(21) Appl. No.: 10/175,025

(22) Filed: Jun. 18, 2002

(51) Int. Cl. H04L 12/66

(52) U.S. Cl. 370/352; 370/356

(57) ABSTRACT

A method and apparatus for sending voice or data notifications to a user using personal computer and voice/data modem is provided. A notification server application is provided to run on a computing device. The notification server checks for the events that the user configured. The event information can be gathered from the Internet, an attached electronic device or any database the computer has a connection to. Once the event satisfies the criteria the user set, the notification server sends a message to the user by placing a phone call or by transmitting it trough a packet network. The notification server executes any commands the user can enter in response to the notification. The commands can be given as DTMF codes or voice if the notification is sent by a phone call. An apparatus for connecting to both public switch telephone networks and packet networks through broadband lines is also provided. The apparatus has an analog voice modem circuit for placing/taking phone calls and a broadband modem circuit for high-speed packet network connection. The apparatus also contains Bluetooth protocol to provide wireless connectivity with other electronic devices. Hence the computer is able to use only one type of hardware to make any sort of communication with any data sources that are not hosted locally.

### CROSS-REFERENCE TO RELATED APPLICATIONS

Not Applicable

### BACKGROUND OF THE INVENTION—FIELD OF INVENTION

This invention generally relates to the field of data communications. More specifically, this invention relates to a method and apparatus for sending voice/data notifications to designated devices (wired phones, cell phones, computers, etc.) using telephony software of a personal computer that has a voice/data modem hardware.

### BACKGROUND OF THE INVENTION

The explosive growth of computer networks has fuelled the demand for communication capabilities between these computers and possible other devices like telephones. One response to this demand is some software that provides the ability to use computers very similar to telephones. This type of software is generally known as computer telephony.

To accommodate computer telephony, many operating systems include telephony application programming interface. It is possible to make or take phone calls using this interface with appropriate devices such as voice modems. Hence a computer's decision making power can be used to manage telephone calls. This kind of call management system targeted business units instead of individuals and is being used for automated call mechanisms of big companies such as banks and insurance firms. These automated call mechanisms answer incoming calls and either direct them to some other number or perform some operation (such as giving information on an account balance or making a credit card payment) according to the menus they provide. However, these sort of systems heretofore are known to suffer from a number of disadvantages:

a) There needs to be several phone lines and computers to handle the amount of customers.

b) These systems are unable to make outgoing calls.

c) There is no notification mechanism due to the necessary amount of phone lines needed.

d) These systems use complicated and expensive devices such as PBX switches to handle phone calls.

e) The end users do not have any control of the options they can pick in these systems. So what these systems offer are not configurable by the customer according to her/his needs. The user is pretty much stuck with whatever the system offers.

Call management systems for individual users seemed to be unnecessary, because in the past they just replaced the answering machine without providing too much value. There are home automation forms of these systems, however they are mainly for controlling home equipment and lack of:

a) Generic notification server that uses information available in the Internet to trigger various notifications.

b) Generic notification server that uses locally available information (from a database or an electronic device) to trigger various notifications.

c) Support for multiple protocols to reach the end-user like Short Messaging System (SMS), Wireless Application Protocol (WAP), e-mail, etc.

d) A single hardware that has both broadband and voice modem capabilities to support easy access to both the Internet and public switch telephone networks.

Also other disadvantages of the home-based systems are as follows:

a) The criteria for any notification are not flexible, so the user cannot change the conditions that need to be met before sending the notification.

b) The user cannot pick the content of the notification he/she will be getting. For example, when a storm breaks the user may want to get weather information where he/she lives or he/she may want to get the traffic information on his/her route instead. Existing systems do not provide either information.

c) The notification gets delivered to only one user. For example, user cannot enroll his/her friends/family members to get the notification.

d) The existing systems also do not perform any action once the condition set is met (instead of sending a notification). For example, user may want to transfer some money to his credit card account immediately (instead of getting notified) when his credit balance is full.

Analog voice/data modems can be used to make/take phone calls. However, their data transfer speed through packet networks is very limited because of the phone line capabilities. On the other hand, broadband modems can handle huge amounts of data with high speed, but they cannot make/take phone calls using public switch telephone network lines. Also, modems are not capable of communicating with other electronic devices.

Accordingly, in light of the above problems, there is a need for a method and apparatus for providing access to the information a personal computer provides as notifications.

### BACKGROUND OF THE INVENTION—OBJECTS AND ADVANTAGES

Besides the objects and advantages of the notification system described in my above patent, there are several objects and advantages of the present invention:

a) To provide fully customizable operations to be executed on the user's computer according to his/her needs, so that the invention lets user to use his/her computer as if he/she is using a terminal.

b) To provide a generic notification mechanism using publicly/privately available data (such as breaking news or traffic information) on the Internet:

i. to decide if the criteria are satisfied for the notification

ii. to build the message regarding to the notification.

For example, user can get a notification that includes a stock price when a house becomes available for sale around the area, so that user knows both there is a house available and if he/she can afford it.

c) To provide a mechanism to perform various actions (instead of sending notifications) when the configured conditions are satisfied. For example the user may configure the system to turn the heat up when a storm breaks in the area.

d) To provide a mechanism for others to make phone calls without having to pay for a phone call. User's friends can post their message to some web site on the Internet (or send it directly to the notification server) as audio file or text file and the notification server will get the message from the Internet if necessary (convert it into an audio file via the help of text-to-speech software if it is text data), call the user and play it.

e) To provide notification mechanism using a local database hosted on the user's computer (such as calendar and memo databases).

f) To provide notification mechanism using the electronic devices that can communicate with the computer. For example, a door lock can be checked regularly by the computer and if gets unlocked the user can be notified accordingly.

g) To provide access to the information that resides in the computer locally or any database the computer has a connection with.

h) To notify by making a phone call or by sending an email or by sending messages in different protocols such as Short Messaging System (SMS) or Wireless Application Protocol (WAP) push according to user's needs.

i) To provide a notification mechanism where the user can control the devices that are attached to (or can communicate with) the computer remotely via the help of telephone (or another computer) in response to the notification he/she gets.

j) To provide a notification system that is available to personal computer users without any special expensive equipment.

k) To provide an apparatus to make/take phone calls through public switch telephone networks and to send/receive data through broadband lines and to make communication with other electronic devices without additional hardware.

Further objects and advantages will become apparent from a consideration of ensuing description and drawings.

### BRIEF SUMMARY OF THE INVENTION

The present invention solves the above problems by providing a method and apparatus for notifying its user by making a phone call or sending an e-mail or using other methods of communication such as SMS messages. Moreover, the present invention provides a method and apparatus for providing direct control of devices attached to the user's computer. The invention uses computer telephony as application programming interface that enables the user to reach her/his personal computer's computing power through voice/data modem. Even though the most common way of communication with computer is through telephone, this invention makes it also possible to use the system through other computers or devices (such as wireless palm devices).

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram illustrating computer networks and the Internet

FIG. 2A is a block diagram showing a conventional way of connecting to the Internet using an analog data modem

FIG. 2B is a block diagram showing connection to the Internet using broadband data channel using a broadband modem

FIG. 3 is a block diagram showing an illustrative operating environment for an actual embodiment of the present invention.

FIG. 4 is a block diagram showing an illustrative local configuration of the present invention.

FIG. 5 is a block diagram showing an illustrative operating environment for the apparatus invented

FIG. 6 is a block diagram showing communication channels of the apparatus invented

FIG. 7 is a flow diagram illustrating a routine for the notification system of the present invention

### DETAILED DESCRIPTION OF THE INVENTION

The present invention is directed to a method and apparatus for notifying its user by making a phone call or sending an e-mail or using other methods of communication such as SMS/WAP messages based on the events selected/configured by the user using a personal computer. Moreover, the present invention provides a remote control mechanism to the user to control any devices attached to the computer either as a response to a notification or as a user-originated communication. According to an embodiment of the invention, the software running on the personal computer of the user is operative to receive a request to access any information available to the computer and to send it accordingly. These and other aspects of the present invention will be described in greater detail below.

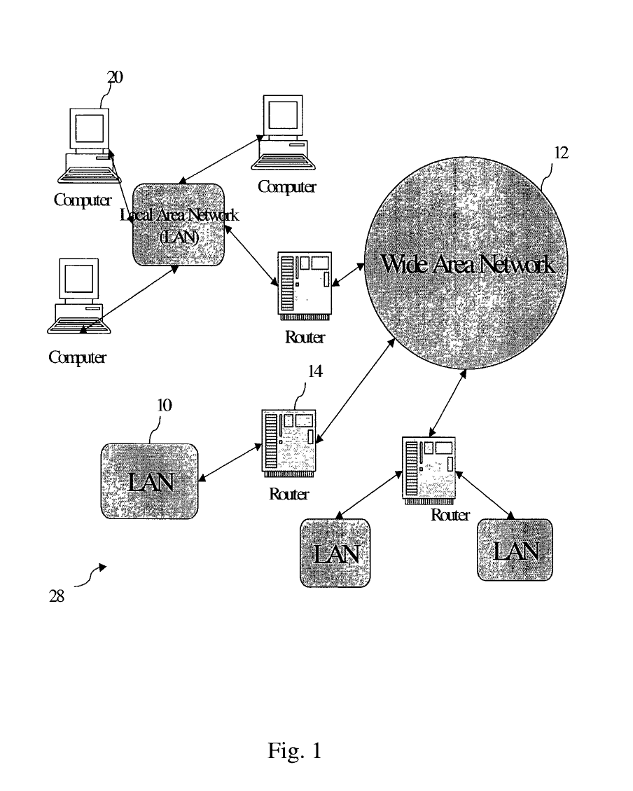

Referring now to the figures, in which like numerals represent like elements, an actual embodiment of the present invention will be described. FIG. 1 shows general aspects of the Internet. As is well known to those skilled in the art, the Internet 28 comprises a collection of networks and routers that use the Transmission Control Protocol/Internet Protocol (“TCP/IP”) to communicate with one another. The Internet 28 typically includes a plurality of local area networks (“LANs”) 10 and wide area networks (“WANs”) 12 that are interconnected by routers 14. Routers 14 are special purpose computers used to interface one LAN 10 or WAN 12 to another. Communication links within the LANs 10 may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, computers, such as remote computers 20, and other related electronic devices can be remotely connected to either the LANs 10 or the WANs 12 via a permanent network connection or via a modem and temporary telephone link. Also wireless devices, such as a WAP-enabled mobile telephone, may connect to the Internet 28 via a wireless data network and including a wireless gateway. It will be appreciated that the Internet 28 comprises a vast number of such interconnected networks, computers, and routers.

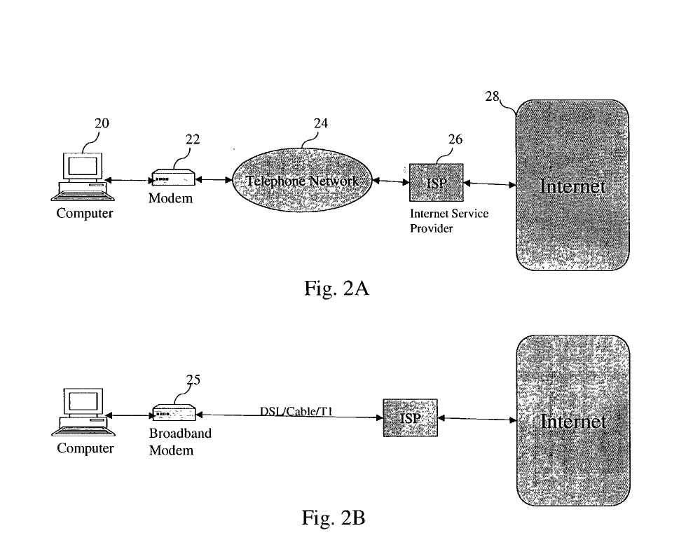

FIG. 2A shows the most common way of connecting to the Internet from a home-based computer 20. The computer uses a device called data modem 22, which converts analog electrical signals from the public switch telephone network (PTN) 24 into digital signals used by the computer and vice versa. Modem uses PTN 24 to dial-up a number to connect to Internet Service Provider (ISP) 26. Hence computer uses the usual phone line to make this sort of connection. ISP 26 is a part of a LAN hence a part of the Internet. The other popular way of connecting to the Internet 28 is using a broadband modem 25 to connect to the ISP directly as shown in FIG. 2B. This type of connection does not use the PTN 24. In this type of the connection provides much greater bandwidth so the data transfer is much faster.

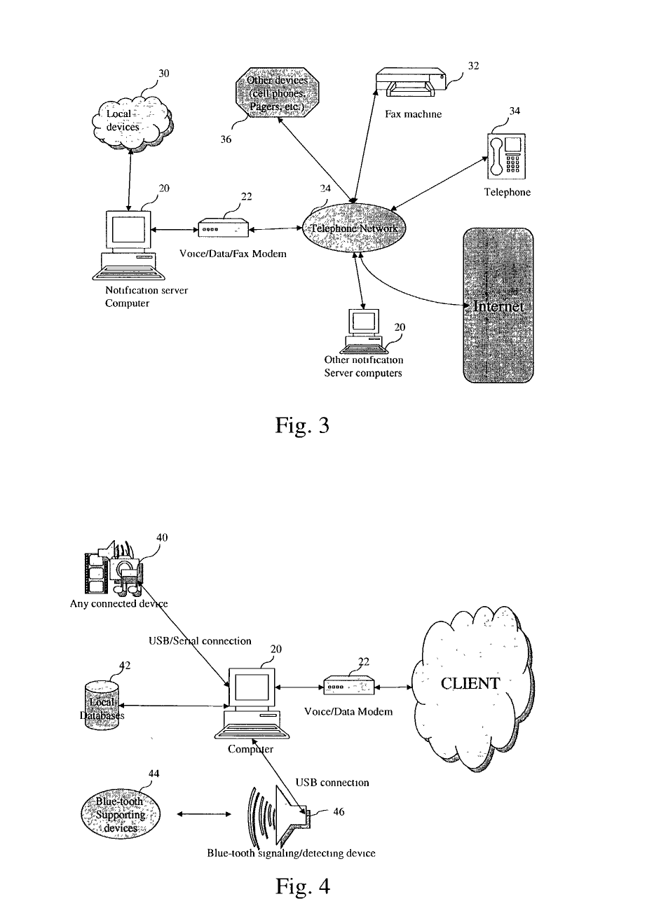

FIG. 3 illustrates an example of a suitable operating environment in which the invention may be implemented. The operating environment is only one example of a suitable operating environment and is not intended to suggest any limitation as to the scope of use or functionality of the invention. Moreover, although aspects of the invention will be described in the general context of an application program that executes on an operating system in conjunction with a server computer, those skilled in the art will recognize that the invention also may be implemented in combination with other program modules.

Generally, program modules include routines, programs, components, data structures, etc. that perform particular tasks or implement particular abstract data types. Those skilled in the art will appreciate that the invention may be practiced with other computer system configurations, including hand-held devices, multiprocessor systems, microprocessor-based or programmable consumer electronics, minicomputers, mainframe computers, and the like.

Referring now to FIG. 3, an illustrative operating environment for an embodiment of the present invention will be described. Aspects of the present invention are implemented as a software application in a personal computer, such as the notification server computer 20. The notification server computer 20 is connected to PTN 24 through a voice/data/fax modem 22. With the voice/data modem 22 besides connecting to the Internet as described above to receive/transmit data it is also possible to make outgoing phone calls or answer incoming phone calls. Moreover, faxing is also possible if the modem supports faxing capabilities. Those skilled in the art should appreciate that other types of modulation/demodulation devices may be utilized without departing from the spirit and scope of the invention. Such device is described referring to FIG. 6 below as a part of the invention. It is possible to attach various local devices 30 to the computer. Hence the notification server software can control these devices based on the commands it can get from a touch-tone telephone or from the Internet 28. Note that these devices can trigger a notification to be sent to a telephone 34, a fax machine 32, a computer on the Internet 20, another notification server computer 20, or any other designated device 36 such as cell phone, pager, etc. The notification server can use other mechanisms to trigger notifications. The details of the process are described below.

FIG. 4 shows how the local configuration of the system can be. It is possible to connect any hardware 40 to the notification server computer 20 using universal serial bus (USB) port, serial port or using other possible interfaces. The computer 20 can either detect any signals from the device to trigger a notification to the end user or send any command, which may or may not be originated by the user, to the connected devices 40. For example; the notification server computer 20 can turn one of the devices on at 5:00 pm everyday or one of the connected devices 40 can sense a movement in a designated area and send a signal to the notification server computer 20 in return the computer 20 can notify the end user accordingly. User can control one of the devices 40 by calling or as a reply to the notification he/she gets. The computer 20 can also use the information in a database 42 to trigger a notification. A calendar database can be used to send memo notifications to the end user. The database 42 may be hosted by the notification server computer 20 or by another computer. Similar to the connected device 40 communication, it is possible to configure the notification server computer 20 to communicate with a Bluetooth signaling device 46 and hence control any Bluetooth supporting devices 44. Bluetooth wireless technology is a worldwide specification for a small-form factor, low-cost radio solution that provides links between mobile computers, mobile phones, and other electronic devices. So the notification server computer 20 can reach many Bluetooth supporting devices 44 without being bound by the number of connections that can be done to the computer 20. These devices 44 can also start the communication depending on their attributes just like the connected devices 40.

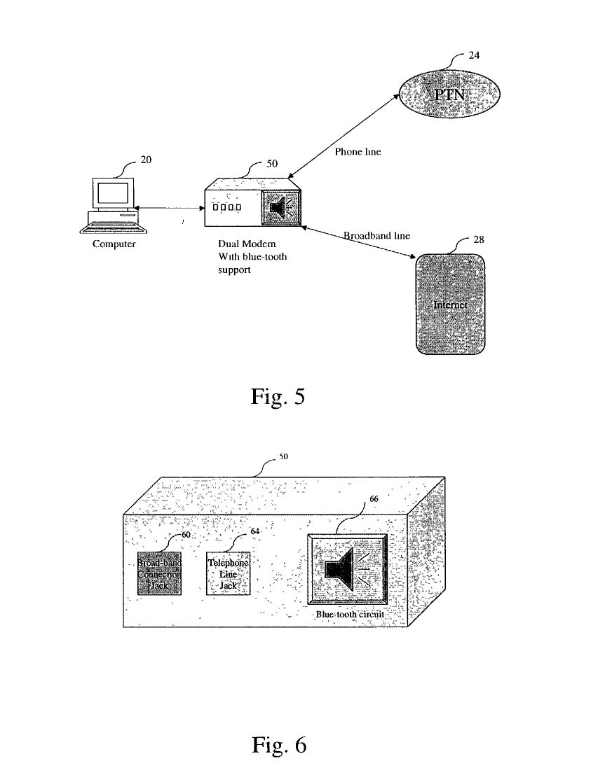

FIG. 5 shows an apparatus 50 that makes the notification server computer 20 to access both the Internet 28 and public switch telephone networks 24. Usually computers have either broadband modems 25 or data modems 22 to connect to the Internet 28. This prevents users to use the connection methods interchangeably. Also, it is not possible to connect to public switch telephone networks 24 using a broadband modem 25, hence it is not possible to make/take phone calls. Broadband modems 25 also do not support faxing capabilities. They are designed for high capacity data transfer. There are protocols such as voice over IP, which enable broadband modems 25 to send voice and video data on the broadband channel, however the receiver needs another computer to interpret the data at the other end of the connection. It is also obvious that these systems cannot take phone calls since they do not have connection to the PTN 24. On the other hand, fax/voice/data modems 22 are able to support up to 56K byte per second data transfer rate due to phone line bandwidth, which is far less than broadband modems 25 are capable of. The dual modem 50 solves the problems associated with the two methods. Broadband connection of the dual modem 50 is designed to access the Internet 28 for fast data transfer and the telephone line connection is designed to make/take phone calls or/and send/receive faxes. The dual modem 50 also has a Bluetooth supporting feature, which enables the computer 20 to be able to send wireless messages to various Bluetooth supporting devices 44. Integrating these three systems lets the computer 20 to make the necessary communication with the outside world through only one device and hence makes both the protocol and hardware to communicate a lot simpler. Installation of such system is also a lot easier given that one device is necessary instead of three. Those skilled in the art should appreciate that even in the absence of the Bluetooth support capability the advantages of a dual modem with broadband and voice/data capacity is high in the light of the description above.

FIG. 6 shows a more detailed illustration of the dual modem 50 described above. The dual modem 50 supports connections to PTN 24 and directly to the Internet 28 through broadband lines such as digital subscription line (DSL), cable, etc. To be able to support these two kinds of connections there are two connection points. The broadband connection jack 60 allows the device to connect to a broadband line. It is possible to have multiple broadband connection jacks to be able to support multiple types of broadband connections such as DSL, cable, etc. The telephone line jack 64 makes it possible for the device to connect to the phone line. The dual modem 50 also supports Bluetooth protocol to make the device a controller without attaching any device using wires. The Bluetooth circuit 66 enables the computer 20 to communicate with other devices without having a wire, so it is possible to communicate with many other devices without any additional hardware.

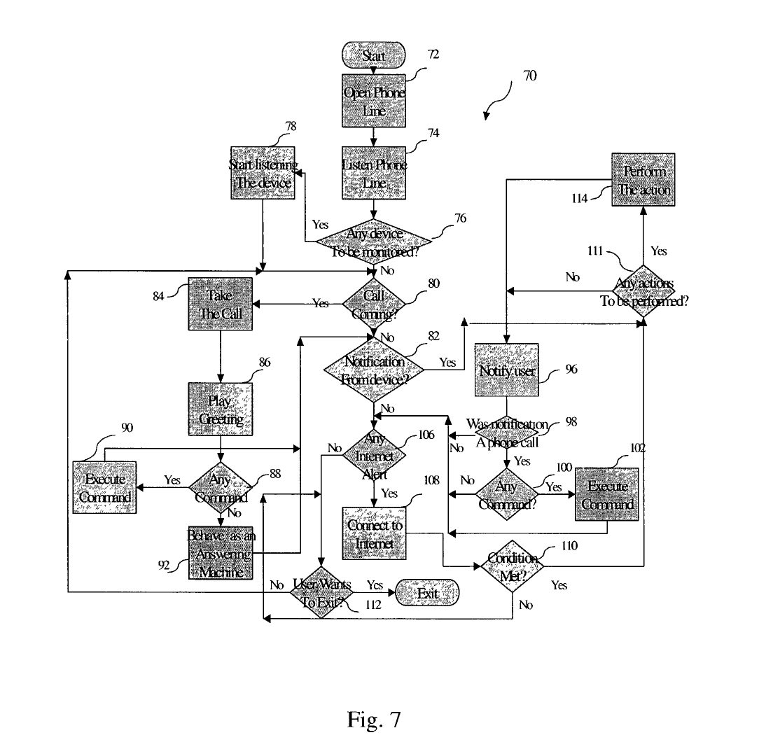

FIG. 7 shows a flow diagram illustrating a routine 70 for the notification system of the present invention. The notification server 20 will run the routine 70 as an application. The routine 70 starts by the user or automatically depending on the configuration. Then the routine 70 opens the phone line at block 72, which is connected to the PTN 24, using telephony application interface to be able to make or take phone calls. At block 74, the routine 70 begins to listen to the line for any phone calls through the PTN 24. At block 76, the routine 70 determines if there is any local device 30 configured to be monitored. If there are local devices 30 available then at block 78 the routine 70 starts to listen to the devices 30 for any event that may trigger a notification. As described above related to FIG. 3, a motion detector connected to the notification server 20 may trigger a notification to be sent to the user.

At block 80, the routine 70 checks if there is an incoming phone/fax call. If there is a phone call it takes the call at block 84, and plays a greeting message at block 86. The routine 70 determines if the caller sends any commands at block 88. The command can be sent through as a DTMF tone by pressing the touch pad of the calling phone or as a voice message. The routine 70 is able to detect DTMF tones, it is also capable of using voice recognition mechanisms to understand the command. If there is a command initiated by the caller, the routine 70 executes the command based on the configuration. The user can configure the routine 70 to make some authentication before executing a command, such as asking a secret code or use voice recognition to distinguish the allowed user's voice. The user can also configure the routine 70 to perform certain actions such as turning one of the connected local devices 30 off based on the commands. At block 90, the routine executes the command the user sends. If there is no command to be executed, then the routine 70 behaves as an answering machine at block 92, which makes the system transparent to the caller.

At block 82, the routine 70 checks if there is any notification originated from the local devices 30. If there is an event that occurred then the routine 70 notifies the user at block 96. Notification can be done by calling the user, sending an e-mail/SMS message or using some other protocol such as WAP push that enables the notification server computer 20 to reach to the end user. If the routine 70 notifies the user by a phone call, then it determines if there is any command to be executed at the block 100. At the block 102, if there is a command in reply to the notification, the routine 70 executes the command based on the previous configuration made by the user. Thus the notification mechanism is totally interactive.

At block 106, the routine 70 determines if there is any alert configured by the user that needs information from the Internet 28. If there is, then the routine connects to the Internet 28 unless it is already connected. The connection can be done through the broadband modem 25 if it exists in the system or the voice/data modem 22 can be used for this purpose. Once the connection is established, the routine 70 can pull the information available to test against the condition set defined previously by the user. For example, user may want to be notified whenever there is an accident on her/his traffic route or whenever breaking news occurs. At the block 110, the routine 70 checks if the information meets the criteria the user set previously. The information can be in extensive mark-up language (XML) format or any other text for evaluation. Those skilled in the art should appreciate that the criteria check can be done in various ways. For example user may want to be notified when there is a certain keyword such as “Seattle Supersonics” appears in the information (which can be sports news that can be gathered from the Internet). If the information satisfies the condition set the user wants, then the routine 70 can perform some actions before notifying the user about the outcome. At the block 111, the routine 70 checks if there is any action it needs to take regarding to the alert it got, then at the block 114 it performs the action and notify the user accordingly as shown at the block 96. For example, user may want to transfer some cash to his credit card account if he/she has no credit left and he/she may want to get notification whether the transfer was successful or not.

If there is no Internet alert configured to be sent or none of the alerts are left to be evaluated then the routine 70 checks if the user wants to exit at the block 112. If there is no request for exiting then the routine 70 goes to the beginning of the block 80 and continues running.

Summary, Ramifications, and Scope

Accordingly, the reader will see that the notification server of this invention can be used to communicate any information accessible through a computer to the user depending on the user's interest. Moreover the user can send various sorts of information to the server to be delivered. Some of possible applications of the method can be:

a) To leave a phone message free of charge. A person can post his/her message as an audio or text file on the Internet. The notification server can get the information, call the user and play the message.

b) To make real-time long distance phone calls free of charge. The notification system of the invention can monitor a local database, which can receive and deliver voice streams (such as Net Meeting). Once the database application gets an incoming audio stream, the notification server can call the user and play the incoming audio stream using telephony API and also can pipe the user's voice reply to the local database to be streamed back in real-time. Hence the person calling the user is able to make a real-time phone conversation with the user without the requirement that the user being in front of the computer.

c) To perform actions instead of notifying the user such as turning the heat down whenever the outside temperature goes above 75 degrees. Hence user intervention can be totally unnecessary.

In light of the above, it should be appreciated by those skilled in the art that the present invention provides a method and apparatus a notification and control system through a modem. While an actual embodiment of the invention has been illustrated and described, it will be appreciated that various changes can be made therein without departing from the spirit and scope of the invention.

The embodiments of the invention in which an exclusive property or privilege is claimed are defined as follows:

1. A method for sending a notification through a modem, comprising:
having a set of conditions required to be satisfied for sending said notification;
getting an event information from a data source;
deciding if said event information satisfies said set of conditions;
creating a message based on said event information;
transmitting said message through said modem.

2. The method of claim 1, wherein said modem comprises sending voice messages through public switch telephone network lines.

3. The method of claim 1, wherein said modem comprises sending data messages through packet networks.

4. The method of claim 1, wherein said data source comprises at least one of:
a. an internet; and
b. an intranet.

5. The method of claim 1, wherein said data source comprises an electronic device that can provide said event information.

6. The method of claim 1, wherein creating said message comprises producing an audio data using said event information.

7. The method of claim 1, wherein said message comprises at least one of:
c. audio data;
d. video data; and
e. text data.

8. The method of claim 1, wherein transmitting said message comprises at least one of:
a. placing a phone call; and
b. sending data through packet network.

9. The method of claim 8, wherein sending data through packet network further comprises at least one of:
a. streaming data;
b. sending data as an instant message;
c. sending data as wireless application protocol push message;
d. sending data as an email; and
e. sending data as short message service message.

10. An apparatus for connecting to both packet networks and public switch telephone networks, comprising:
means for placing and taking phone calls;
means for sending and receiving data through broadband lines,
whereby a computer can communicate with other networks more efficiently.

11. The apparatus of claim 10, wherein said means for placing and taking phone calls comprises an analog voice modem circuit.

12. The apparatus of claim 10, wherein said means for sending and receiving data through broadband lines comprises a broadband modem circuit.

13. The apparatus of claim 12, wherein said broadband modem circuit comprises at least one of:
a. a digital subscriber line modem circuit; and
b. a cable modem circuit.

14. The apparatus of claim 10, further including means for communicating with electronic devices.

15. The apparatus of claim 14, wherein said means for communicating comprises a circuit that supports bluetooth wireless protocol.

16. A method for providing interactive communication after sending a notification to a user by making a phone call, comprising:
receiving a request sent by said user as a response to said notification;
mapping said request into a command;
executing said command.

17. The method of claim 16, wherein receiving said request comprises at least one of:
a. recognizing said user's voice; and
b. detecting dual tone multiple frequency code.

18. The method of claim 16, wherein executing said command comprises controlling electronic devices attached to the computer that sends said notification.
